(19) United States
(12) Patent Application Publication
(10) Pub. No.: US 2022/0014388 A1
(43) Pub. Date: Jan. 13, 2022

(54) VIRTUAL SECURITY GUARD

(71) Applicant: SERA4 LTD., Waterloo (CA)

(72) Inventor: Jerod D. KLINK, Kitchener (CA)

(21) Appl. No.: 17/371,911

(22) Filed: Jul. 9, 2021

Related U.S. Application Data
(60) Provisional application No. 62/705,667, filed on Jul. 9, 2020.

(51) Int. Cl. H04L 9/32; H04W 12/069; H04W 12/63

(52) U.S. Cl. CPC H04L 9/3268; H04W 12/63; H04W 12/069

(57) ABSTRACT

A security device includes a network interface, a short-range wireless interface and a processor coupled to the wireless interface. The short-range wireless interface communicates with a wireless mobile device in a vicinity of a location of the security device. The processor is configured to detect a signal received from the wireless mobile device in the vicinity of the location, receive a cryptographic certificate from the wireless mobile device via the wireless interface and automatically register the user to the location of the security device by sending the cryptographic certificate to a server via the network interface. The cryptographic certificate is associated with an identity of a user of the wireless mobile device.

### FIELD

This invention relates to security, more specifically, the invention relates to secure access to physical resources.

### BACKGROUND

Controlling access to physical resources, such as buildings, yards, or compounds, often requires a dedicated person, such as a security guard, to receive visitors.

The security guard collects information from visitors entering the building and may verify a visitor's identity using traditional means, such as identity cards. This process of collecting a visitor's data and verifying their identity may be inefficient, cumbersome, and prone to the risks of theft or misuse of assets.

Known techniques for securing physical resources include electronic locks that may be configured to respond to the presence of an access card, key code, or similar. More recent systems use smartphones to open electronic locks. However, even if a physical resource is secured by an electronic lock, the site where the physical resource is located may be insecure. This may cause other physical resources at the site to be at risk. In some cases, an insecure site may also cause an asset located at the site and protected by an electronic lock to be at risk if the electronic lock is not used properly.

Moreover, smartphones or access cards or other similar ways to unlock electronic locks do not provide control over the number of visitors trying to access the physical resource. Multiple other visitors may tag along with an authorized visitor to the site who has access to the physical resource.

### SUMMARY

According to an aspect of the disclosure, a security device is provided. The security device comprises a network interface, a short-range wireless interface to communicate with a wireless mobile device when the wireless mobile device is in a vicinity of a location of a security device. The security device further includes a processor coupled to the wireless interface and the network interface. The processor is configured to detect a signal received from the wireless mobile device in the vicinity of the location and receive a cryptographic certificate from the wireless mobile device via the wireless interface. The cryptographic certificate is associated with an identity of a user of the wireless mobile device. The processor is further configured to automatically register the user to the location of the security device by verifying the cryptographic certificate or by sending the cryptographic certificate to a server via the network interface.

According to another aspect of the disclosure, a server is provided. The server comprises a network interface and a processor coupled to the network interface. The processor is configured to receive a cryptographic certificate from a security device via the network interface. The cryptographic certificate is received by the security device from a wireless mobile device in a vicinity of a location of the security device. The processor is further configured to verify the cryptographic certificate using a key of an authorizing party to register the user as an authorized visitor to the location.

According to another aspect of the disclosure, a wireless mobile device is provided. The wireless mobile device comprises a wireless interface, a user interface and a processor coupled to the wireless interface and the user interface. The processor is configured to communicate with a security device via the wireless interface when the wireless mobile device is in a vicinity of a location of the security device. The processor is further configured to send a cryptographic certificate to the security device via the wireless interface to register a user of the wireless mobile device as visiting the location of the security device.

### BRIEF DESCRIPTIONS OF THE DRAWINGS

Embodiments are described with reference to the following figures.

FIG. 1 is a schematic diagram of an example site for providing secure access to a physical resource.

FIG. 2 is a schematic diagram of an example security device.

FIG. 3 is a schematic diagram of the security device of FIG. 2 interacting with a wireless mobile device and a user of the device.

FIG. 4 is a schematic diagram of the security device of FIG. 2 sending a prompt to a wireless mobile device for voluntary information.

FIG. 5 is a schematic diagram of an example system for providing secure access to a site and a physical resource at the site.

FIG. 6 is a schematic diagram of a server that is operable with a security device.

FIG. 7 is a schematic diagram of the server of FIG. 6 and a security device of FIG. 2 issuing an alert when more people are on site than a registered number of people.

FIG. 8 is a schematic diagram of the security device of FIG. 2 interacting with the lock controller of FIG. 5.

FIG. 9 is a schematic diagram of an example wireless mobile device that is operable with a security device.

### DETAILED DESCRIPTION OF THE EMBODIMENTS

The present invention aims to solve at least one of the problems discussed above. Specifically, the present invention uses a security device, which may be termed a virtual security guard or site security device, to register visitors who are on-site regardless of whether or not cryptographic electronic locks that are located at the site are accessed. The present invention registers visitors using digital certificates. Thus, the security device acts as an additional layer of security to any electronic locks present at the site. The security device may complement the use of cryptographically secure electronic locks or may be used on a site without such electronic locks.

The security device automatically registers and authenticates users visiting a site. Unlike the traditional manual way of registering visitors, the security device presents a highly efficient and secure solution to protect a site. The security device is particularly useful for remote sites with infrequent visitors, where a human security guard would be impractical.

The security device can be installed at an entrance of a site and positioned to be hidden from view and, hence, reduce the likelihood of detection and tampering.

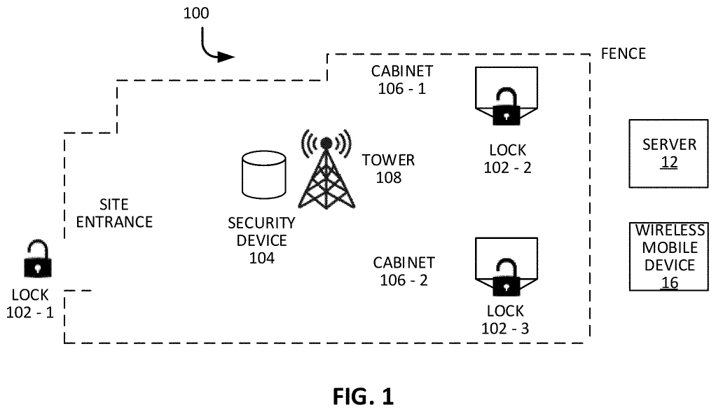

FIG. 1 is a schematic diagram of an example site 100 using a security device 104 for providing secure access to a physical resource.

The physical resources guarded by the present invention may be situated at sites at remote geographic locations. Examples of such resources include cell tower shacks, oilfield installations, construction equipment and sites, remote industrial facilities, and similar. The physical resources guarded by the present invention may include industrial or commercial fixtures, such as storage cabinets, lockers, storerooms, yards, and similar. A salient example of a physical resource is a fenced site that has a cell tower shack that contains valuable equipment such as network devices and high-capacity batteries. That said, the preceding are merely examples of the types of physical resources suitable for use with the present invention and they should not be taken as unduly limiting.

The site 100 includes a plurality of locks 102-1, 102-2 and 102-3 placed at different locations to secure access to the site 100. The lock 102-1 is located at a site entrance which needs to be unlocked to enter the site premises. Locks 102-2 and 102-3 protect physical resources such as cabinets 106-1 and 106-2. A security device 104 may be located near the site entrance. The security device 104 may be located at any position that may be hidden from users visiting the site 100. The security device 104 may be, for example, placed on a tower 108.

The security device 104 communicates with a wireless mobile device 16 carried by a visitor entering the site entrance through the lock 102-1, which may be a conventional lock or a cryptographically secure electronic lock. At about the same time, the security device 104 receives a cryptographic certificate from the wireless mobile device 16 and automatically registers the user of the wireless mobile device 16 as a visitor to the site 100 by sending the cryptographic certificate to a server 12, which may be located remote from the site 100 or located at the site 100.

The cryptographic certificate stored at the wireless mobile device 16 may be initially generated at the server or at least may be known to the server 12. For example, prior to the visit, the wireless mobile device 16 may generate a pair of public and private key for the user and may upload the public key to the server 12. The server 12 may then sign this information and generate the cryptographic certificate which is shared with the wireless mobile device 16. When the user visits the site 100, the wireless mobile device 16 is carried by the user. Access permissions are associated with user accounts in a database maintained at the server 12. The user logs into his/her account using, for example, a unique username and password with their wireless mobile device 16. In response to a successful log in, the wireless mobile device 16 shares the cryptographic certificate with the security device 104.

Once the security device 104 receives the cryptographic certificate from the wireless mobile device 16, the security device 104 may verify the cryptographic certificate and register the wireless mobile device 16. In other examples, the security device 104 may send the cryptographic certificate to the server 12 via a long-range network interface (e.g., Wi-Fi, a cellular network, etc.) and the server 12 may verify the certificate using the public key. If the certificate is verified, then the user of the wireless mobile device 16 may be considered an authorized visitor to the site 100. If the certificate is not verified, then action may be taken, such as logging an unauthorized visitor, transmitting an alert to a site authority, and so on.

In some examples, the security device 104 may challenge the identity of the user of the wireless mobile device 16 for enhanced security measures. The security device 104 may challenge the identity received in the form of cryptographic certificate by encrypting a message to the wireless mobile device 16 and prompting the wireless mobile device 16 to decrypt the message. If the message is decrypted successfully, then the security device 104 may trust the wireless mobile device 16.

The security device 104 may also detect different events related to locks 102-2 and 102-3 which guard the cabinets 106-1, 106-2 and relay the events to the server 12 in real-time. For example, the security device 104 can detect when the locks 102-2 are opened or when the locks 102-2 are being accessed and not opened (e.g., potentially tampered with).

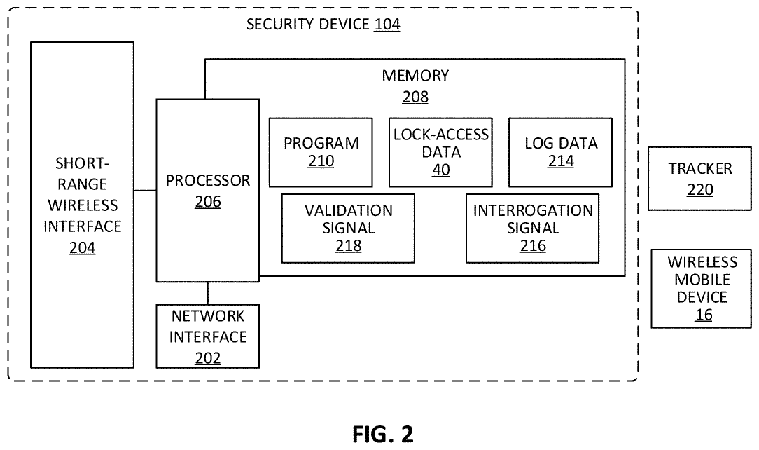

The components of the security device 104 will now be discussed in detail with reference to FIG. 2. The security device 104 includes a network interface 202, a short-range wireless interface 204, a processor 206 and a memory 208.

The network interface 202 is configured for bidirectional data communications through a computer network (not shown) and may be used to communicate with the server 12. The network interface 202 includes a network adaptor and driver suitable for the type of network. The short-range wireless interface 204 includes a short-range communications interface such as Bluetooth, Bluetooth Smart, Bluetooth Low Energy or BLE, Wi-Fi, ZigBee, Google Thread, Near Field Communication or NFC, etc.

The processor 206 may include one or more central-processing units (CPU), microcontrollers, microprocessors, processing cores, field-programmable gate arrays (FPGA), and similar. All or some of the memory 208 may be integrated with the processor 204. The memory 208 includes any combination of read-only memory (ROM), random-access memory (RAM), flash memory, magnetic storage, optical storage, and similar for storing instructions and data as discussed herein. The processor 206 and memory 208 cooperate to execute instructions to cause the security device 104 to perform the functionality discussed herein.

As one or more wireless mobile devices 16 approach a vicinity of a location of the security device 104, the processor 206 may detect a signal from a wireless mobile device 16 through the short-range wireless interface 204. The detected signal may cause the security device 104 to automatically attempt to connect to the wireless mobile device 16. For example, when a user carrying a wireless mobile device 16 enters the site 100, the user logs into their account, using a unique username and password, with their wireless mobile device. This causes the wireless mobile device 16 to emit a signal that is monitored for by processor 206 of the security device 104, thereby enabling the processor 206 to detect the wireless mobile device 16. This action automatically causes the security device 104 to connect to the wireless mobile device 16. When the user logs into their account the user may provide identification details such as name, email address, phone number and the like. In other examples, the wireless mobile device 16 may periodically emit a signal that is monitored for by the security device 104. Alternatively, the short-range wireless interface 204 may periodically emit a signal that is monitored for by the wireless mobile device 16. In various examples, initial communication between the security device 104 and the wireless mobile device 16 may trigger the wireless mobile device 16 to prompt the user of the wireless mobile device 16 to log into their account, so as to initiate registration of the user as a visitor to the site. In other examples, the security device 104 may automatically initiate registration of the user as the visitor if the user is already logged in to their account.

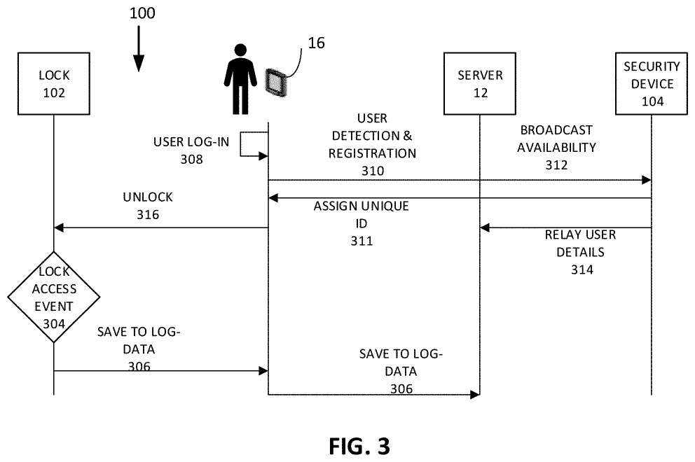

In some examples, once the processor 206 registers the wireless mobile device 16 to the security device 104, the processor 206 may assign a unique ID to the wireless mobile device 16. The wireless mobile device 16 may be configured to periodically broadcast the unique ID, and the processor 206 may be configured to detect the unique ID and monitor the duration of time that the wireless mobile device 16 is present at the site 100. This is depicted in FIG. 3 with reference to components from FIG. 2.

In FIG. 3, at step 308, a visitor logs into an application executed by the wireless mobile device 16 using a unique username and password. At step 310, the security device 104 detects the user using a short-range wireless interface and registers the identity of the user. At step 311, the security device 104 assigns a unique ID to the wireless mobile device 16.

At step 312, the wireless mobile device 16 starts to broadcast the unique ID so that the security device 104 may monitor the duration the user visits the site. In some examples, the wireless mobile device 16 may additionally broadcast availability as it reaches the vicinity of the location of the security device 104. The wireless mobile device 16 and the security device 104 may detect each other through wireless communication, such as Bluetooth or Wi-Fi. The wireless communication causes the wireless mobile device 16 to broadcast availability as the wireless mobile device 16 detects the security device 104. At step 314, the security device 104 relays the user details used to register the wireless mobile device 16 to the server 12. At step 316, the application at the wireless mobile device 16 unlocks a lock 102 and allows access to the user. The lock 102 may be located at the entrance of the site 100 or inside the site 100 guarding the physical resources such as cabinets 106-1 and 106-2 at the site 100. In some examples, the security device 104 may provide a required component of lock access data (e.g., a full key or a part of key) that would be required to unlock cabinets 106-1 and 106-2 on the site 100. In this case, the registration of the user of the wireless mobile device 16 with the security device 104 is a prerequisite action to unlocking a cabinet 106-1 or 106-2, as the user will not be able to access the physical resources without the required full key or partial key to the locks 102-1 or 102-3. Thus, enhanced security of the physical resources is provided. The lock 102 may be unlocked by the application executed by the wireless mobile device 16 once the wireless mobile device 16 is registered with the security device 104.

Once the lock 102 is unlocked, at step 304, a lock access event is generated in the server 12 and optionally at the security device 104. At step 306, the lock access event 304 is saved as log-data at the wireless mobile device 16 and the wireless mobile device 16 transfers this log-data to the server 12. As discussed previously with regard to FIG. 1, the security device 104 may also be connected to a plurality of lock controllers guarding a plurality of electronic locks located at the site 100 through the network interface 202. Thus, the security device 104 also has the capability to monitor events happening near the vicinity of the location of the electronic locks and store such data as log data 214. The security device 104 then forwards the log-data 214 to the server 12. For example, the security device 104 may detect physical movements or tampering of the locks and initiate an alarm as soon as the detection occurs.

The automatic connection between the security device 104 and the wireless mobile device 16 may be done without notifying the user. This may help prevent theft or physical/electronic tampering with the security device 104 by unauthorized users. However, the automatic connection information may be provided to an administrator or owner of the security device 104. This may help such parties to keep track of users visiting the site 100.

Returning to FIG. 2, the function of the processor 206 of the security device 104 is described in detail. The processor 206 is configured to receive a cryptographic certificate from the wireless mobile device 16 via the short-range wireless interface 204. The cryptographic certificate is associated with an identity of a user of the wireless mobile device 16 previously authenticated by the server 12. That is, prior to the visit to the site, the wireless mobile device 16 generates a pair of public and private key for the user and uploads the public key to the server 12. The server 12 signs this information and generates the cryptographic certificate which is shared with the wireless mobile device 16. It is this cryptographic certificate which is then provided by the wireless mobile device 16 to the security device 104.

When the user visits the site, the user logs in to an application executed by the wireless mobile device 16 and provides a username and password or other login information. Once the user is logged in, the wireless mobile device 16 sends the cryptographic certificate to the processor 206 of the security device 104 via the short-range wireless interface 204. The processor 206 receives the cryptographic certificate and may verify the cryptographic certificate and register the wireless mobile device 16. In some examples, the processor 206 may send the cryptographic certificate to the server 12 via the network interface 202 for verification. In this case, the server 12 verifies the cryptographic certificate and allows the processor 206 to register the user to the location of the security device 104. Thus, each user with a wireless mobile device 16 is registered when each user logs into their respective accounts using their wireless mobile device 16 and their cryptographic certificates are verified by the processor 206 of the security device or by the server 12. In some examples, the processor 206 may send a registration confirmation to the wireless mobile device 16 once the cryptographic certificate is verified by the server 12. In other examples, the processor 206 may send a registration failed indication to the wireless mobile device 16 if the cryptographic certificate is not verified by the server 12. In other examples, the site security device 104 may send additional information about the site 100 to the wireless mobile device 16, such as site availability notices (e.g., “access to this site is restricted between 01:00 PM to 05:00 PM”), safety messages (e.g., “hardhat and safety glasses required”), or similar messages relevant to the visitors of the site. Further, if the cryptographic certificate is configured to contain information identifying the visitor, the visitor's role, or the visitor's organization, such additional information may be customized to the individual visitor, role, or organization.

The security device 104 further includes a program 210. The program 210 is configured to manage connections and account credentials with the server 12 and to receive lock-access data 40 from the server 12. The lock-access data 40 includes data such as virtual keys that grants access to the physical resource at the site. The lock-access data may be sourced from the server 12. Thus, when the user of the wireless mobile device 16 is registered with the security device 104, the user may be provided lock-access data 40 to access electronic locks 102-2 guarding the physical resources 106-1, 106-2.

The program 210 can further be configured to handle discovery/pairing with wireless mobile devices 16, electronic lock controllers, as well as setup and expiry of short-range communications sessions with electronic lock controllers, according to the particular communications scheme used. (e.g., Bluetooth, BLE, etc.)

The program 210 can further be configured to manage log data and send it to the server 12 when required. The log data may include for example, date and time of entry of a registered user, duration of stay of the registered user, count of the number of users and the like.

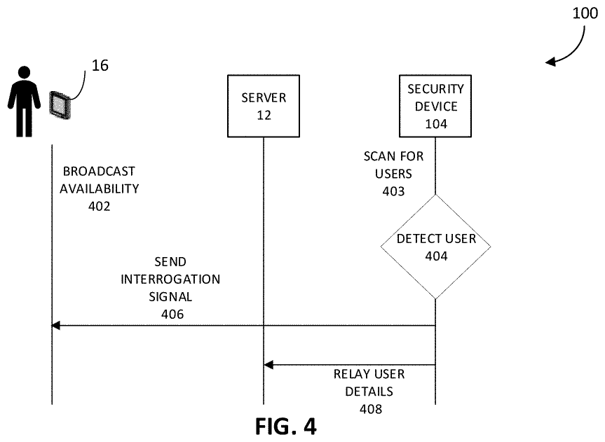

The processor 206 may be further configured to send an interrogation signal 216 saved at the memory 208 to the user of the wireless mobile device 16. The interrogation signal is configured to prompt the user for voluntary information concerning a visit by the user to the location. For example, the interrogation signal may prompt the user to summarize the reason for visit to the site 100. This is depicted in FIG. 4, which shows the security device 104 sending an interrogation signal to the wireless mobile device 16 for voluntary information.

In FIG. 4, at step 402, the wireless mobile device 16 broadcasts availability using a short-range wireless interface. At step 404, the security device 104 detects the user by way of the broadcast by the wireless mobile device 16. At step 406, the security device 104 sends the interrogation signal to the wireless mobile device 16. The interrogation signal operates as a prompt for details such as reason for visiting, estimated time duration to spend at the site, details of specific location within the site that need to be accessed, and the like.

With reference back to FIG. 2, the processor 206 of the security device 104 may be further configured to send a validation signal 218 to validate the user's identity in the form of the cryptographic certificate. The security device 104 encrypts a message to the wireless mobile device 16 using a public key of the wireless mobile device 16. The validation signal 218 is configured to prompt the wireless mobile device 16 to decrypt the message and respond to the security device 104 accordingly. The validation signal 218 is sent to the wireless mobile device 16 before the security device 16 registers the user of the wireless mobile device 16 as an authorized visitor to the site 100. Thus, if the wireless mobile device 16 does not decrypt the message, the security device 104 does not register the user as an authorized visitor to the site 100.

The processor 206 of the security device 104 may be further configured to detect that the wireless mobile device 16 has left the vicinity of the location when the detected signal from the short-range wireless interface vanishes from the vicinity of the location of the security device 104. For example, the processor 206 may track a predetermined amount of time when it does not receive a signal from the wireless mobile device 16. Once the predetermined amount of time has passed, the processor 206 may log the duration of the wireless mobile device 16 at the site and save it as log-data 214 in the memory 208 in the security device 104. The security device 104 may forward the log-data 214 to the server 12.

The security device 104 may be connected to a tracker 220. The tracker 220 may be configured to detect people and send visitor detection data to the processor 206. The processor 206 may be configured to process the visitor detection data to count the number of people at the site 100. In some examples, the tracker 220 may be connected to the server 12 and the server 12 may process the visitor detection data to count the number of people at the site 100.

In some examples, the tracker 220 may be a camera configured to capture images of the users and count the number of users captured in the images. Motion detection or face detection may be used. In other examples, the tracker 220 may use local detection techniques, such as infrared beams, to track people entering or leaving the site 100. Other devices to count the number of people are also contemplated.

In some examples, the tracker 220 may be located near the security device 104 at a location in the vicinity of the entrance to the site 100. In other examples, the tracker may be integrated to the security device 104.

The processor 206 of the security device 104 collects information such as the cryptographic certificate, voluntary information, and a count of number of people, and sends the collected information to the server 12. The server 12 processes the received information and helps verify the identity of the user. The components of the server 12 will be detailed below.

The processor 206 of the security device 104 may be further configured to detect a physical change to the security device 104. For example, the security device 104 may contain a sensor to detect movement or tampering of the security device 104, the sensor may be configured to send detected signals to the processor 206. The processor 206 may be configured to initiate an alarm in response to the detected signals. In some examples, the processor 206 may further be configured to send detected signals to the server 12.

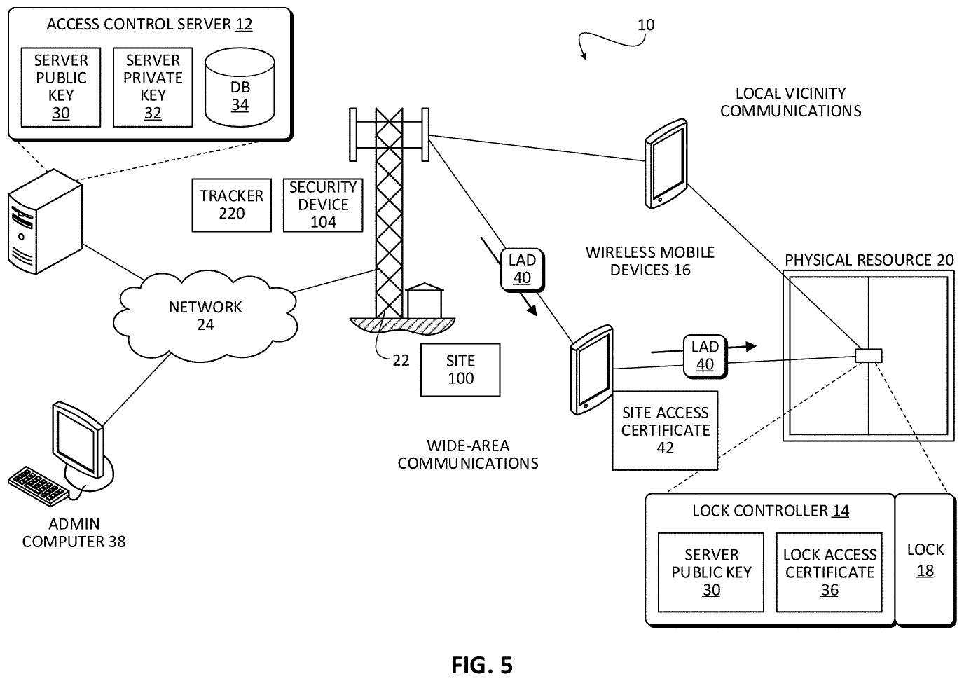

FIG. 5 depicts an overall system 10 for providing secure access to a physical resource at a site 100 according to the present invention. The system 10 includes security device 104 located at a tower of a network infrastructure 22, an access control server 12, an electronic lock controller 14, and a plurality of wireless mobile devices 16 carried by users visiting the site 100. The lock controller 14 unlocks a physical lock 18 that restricts access to a physical resource 20. Unlocking is based on access requests made by the wireless mobile devices 16, as controlled by access permissions managed by the access control server 12. The system 10 can include any number of access control servers 12, electronic lock controllers 14, and wireless mobile devices 16 to restrict access to any number of physical resources 20.

The wireless mobile devices 16 are configured to connect to the access control server 12 via a computer network 24. The computer network 24 includes one or more internet protocol (IP) networks, such as an intranet, a local-area network, a wide-area network, a virtual private network (VPN), a Wi-Fi network, the internet, and similar. Any suitable protocol, such as TLS and HTTPS, can be used for secure data communications. The computer network 24 can include cellular/mobile network infrastructure 22 that operates according to any type of cellular/mobile network technology and standard (e.g., 2G, 3G, 4G, GSM, UMTS/UTRA, HSPA, LTE, CDMA, WiMAX, etc.) that provides for relatively long-range wireless communications. Generally, the computer network 24 uses grid power and has wired components (e.g., Ethernet, fiber optics, etc.).

The access control server 12 stores a public key 30 and a corresponding private key 32. The keys 30, 32 may be generated according to any asymmetric cryptographic scheme or equivalent cryptographic scheme. For example, NIST-approved elliptical curve cryptography can be used. The access control server 12 further stores a database 34 that stores a plurality of user accounts for users of the wireless mobile devices 16 to be provided with secure access to the physical resource 20. One or more administrator computers 38 can be provided to manage the access control server 12, and particularly manage the user accounts and which users have access to which physical resources at what times.

The lock controller 14 stores a lock-access certificate 36 that includes a public key and a corresponding private key for the particular lock 18. Each lock controller 14 has its own unique lock-access certificate 36. The public and private keys of the lock controller 14 also accord to the selected asymmetric cryptographic scheme. Keys of any suitable bit length (e.g., 64-bit, 128-bit, 256-bit, etc.) can be employed based on the desired level of security. In addition, the lock-access certificate 36 has been previously digitally signed by the private key 32 of the server 12. Signing of the lock-access certificate 36 with the private key 32 of the server 12 is preferably done in a secure environment, such as at a factory that manufactures lock controllers and provisions access control servers. The lock controller 14 further stores the public key 30 of the access control server 12.

The wireless mobile devices 16 are carried by users who are to be granted access to the physical resource 20. Access permissions are associated with user accounts in the database 34. A user logs into his/her account, using for example a unique username and password, from their wireless mobile device 16 to obtain from the server 12 lock-access data 40 that grants access to the physical resource 20 or grants another permission with respect to the lock controller 14.

The wireless mobile device 16 and electronic lock controller 14 may be configured to mutually connect for data communications when within local vicinity of each other. That is, each of the wireless mobile devices 16 and the electronic lock controller 14 has a local-range communications interface, which can include a chipset and/or antenna/transceiver operable according to any suitable short-range wireless communications scheme (e.g., Bluetooth, Bluetooth Smart, Bluetooth Low Energy or BLE, Wi-Fi, ZigBee, Google Thread, Near Field Communication or NFC, etc.), short-range audio communications scheme, short-range infrared communications scheme, or similar technology. The particular short-range communications scheme selected is not specifically limited, though its range is shorter than that provided by the computer network 24. However, because the present invention concerns granting physical access to remote physical resources that may not have access to grid power, it is contemplated that shorter-ranged schemes will generally be more advantageous due to reduced power consumption. The presently preferred short-range communications schemes include Bluetooth and BLE.

The wireless mobile device 16 and electronic lock controller 14 may be configured to mutually connect for data communications over the computer network 24 (e.g., over the internet).

Concerning operation of the system 10, in overview, the server 12 digitally signs lock-access data 40 specific to the user and the lock controller 14 using its private key 32 prior to transmitting the lock-access data 40 to a wireless mobile device 16 of a user who wishes to gain access to the physical resource 20. The wireless mobile device 16 obtains a site-access cryptographic certificate 42 from the server 12. When the wireless mobile device 16 is in the vicinity of the location of the security device 104, for example, the entrance of the site 100, the security device 104 detects the wireless mobile device 16 and receives the site-access cryptographic certificate 42 and verifies the site-access cryptographic certificate 42. In some examples, the security device 104 may send the site- access cryptographic certificate 42 to the server 12 for verification.

After the wireless mobile device 16 is verified by the security device 104 or the server 12, the wireless mobile device 16 obtains the lock controller's server-signed lock-access certificate 36 from the lock controller 14, when in vicinity of the lock controller 14, and validates the authenticity of the lock-access certificate 36, and thus the authenticity of the lock controller 14 itself, using the server's public key 30. Once validated, communications between the wireless mobile device 16 and the lock controller 14 can be secured on the basis of the lock controller's lock-access certificate 36. The wireless mobile device 16 can safely encrypt the lock-access data 40 using the lock controller's public key and transmit the encrypted lock-access data 40 to the electronic lock controller 14, which can use its private key to decrypt the lock-access data 40. The lock controller 14 can validate the authenticity of the lock-access data 40 using the server's public key 30. If the lock-access data 40 is successfully validated, the lock controller 14 performs one or more operations defined by the lock-access data 40, such as unlocking the lock 18. Similar processes can be used to allow the server 12 to update settings of the lock controller 14, to communicate data (e.g., log data) from the lock controller 14 to the server 12, and to confirm that the lock 18 has been properly locked after access to the resource 20 is completed. The above process can also be used to lock the lock 18, although it is contemplated that unlocking the lock 18 will generally be more of a security concern.

It is advantageous that the wireless mobile device 16 is registered to the site 100 using a site-access certificate 42, so that the user's visit to the site 100 is tracked and so that unauthorized visits may be recorded or alerted. It is further advantageous that a wireless mobile device 16 may be required to obtain lock-access data 40 from the security device 104 in order to be able to communicate with lock controllers 14 on the site, so that the registration of the wireless mobile device 16 to the security device 104 may be enforced as a necessary step in accessing physical resources protected by the lock controllers 14. It is further advantageous that the wireless mobile device 16 and the lock controller 14 communicate using a lock-access certificate 36 assigned to the lock controller 14. The server 12 signs both the lock-access data 40 and the lock controller's lock-access certificate 36, advantageously allowing the lock controller 14 and the wireless mobile device 16, respectively, to validate the authenticity of the lock-access data 40 and the lock controller's lock-access certificate 36. This allows the lock controller 14 to detect forged lock-access data and respond appropriately by, for example, not opening the lock 18, logging an unauthorized access attempt, issuing an alarm, or similar. In addition, the wireless mobile device 16 can detect an impostor lock controller and respond appropriately by, for example, not transmitting the lock access data, notifying the server 12 of the location of the unauthorized lock controller, and similar. Moreover, registration of visitors to the site 100 using site-access certificates 42 may help protect physical resources that do not use a lock controller 14 (instead perhaps using a traditional lock or low-security electronic lock) or may add an extra layer of security above the cryptographically secure lock controller 14.

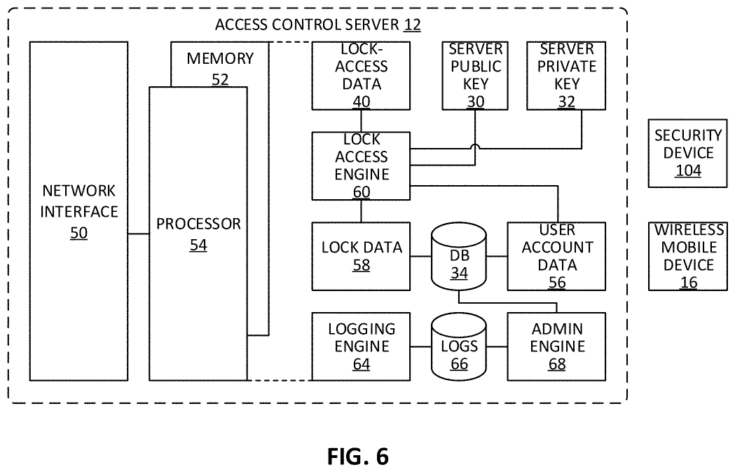

FIG. 6 shows a schematic diagram of the access control server 12. The server 12 is one example of a server that can be used with the system 10. The term server as used herein refers to a single server or multiple cooperating servers.

The server 12 includes a network interface 50, memory 52, and a processor 54. The network interface 50 is configured for bidirectional data communications through the computer network 24. The network interface 50 includes a network adaptor and driver suitable for the type of network 24. The memory 52 includes any combination of read-only memory (ROM), random-access memory (RAM), flash memory, magnetic storage, optical storage, and similar for storing instructions and data as discussed herein. The processor 54 includes one or more central-processing units (CPU), microcontrollers, microprocessors, processing cores, field-programmable gate arrays (FPGA), and similar. All or some of the memory 52 may be integrated with the processor 54. The processor 54 and memory 52 cooperate to execute instructions to cause the server 12 to perform the functionality discussed herein.

As mentioned above, the server 12 stores the server's public and private keys 30, 32 in addition to the database 34. The database 34 stores user account data 56 and lock data 58. The server 12 digitally signs public key of the wireless mobile device 16 specific to the user using its own private key 32. When the wireless mobile device is detected by the security device 104, the security device 104 receives a cryptographic certificate and the processor 54 integrated in the server 12 is configured to receive a cryptographic certificate from the security device 104 via the network interface 50. The processor 54 verifies the cryptographic certificate using the public key 30 to authorize a user of the wireless mobile device 16 as an authorized visitor to the site. The processor 54 is further configured to initiate an alert when the cryptographic certificate cannot be verified. Suitable alerts issued by the processor 54 include an email, text message, or prompt in a user-interface (e.g., dashboard) provided by the server 12. In some examples, the processor 54 may be further configured to generate reports of visitors, visit times, reasons for visit, and whether visitors were successfully registered or not.

The processor 54 is further configured to receive voluntary information of the user of the wireless mobile device 16 via the security device 104. The voluntary information may comprise reason for visiting the location/site, estimated time duration to spend at the site, details of specific location within the site that need to be accessed, etc. The voluntary information is stored in the database 34 as user account data 56.

The processor 54 is further configured to receive a count of number of people in the vicinity of the location of the security device 104 via the tracker 220 connected to the security device 104 or the server 12. For example, the security device 104 may send the count of number of people via the tracker 220 between a predetermined duration of time and update the count at predetermined intervals.

In some examples, the tracker 220 may be a camera configured to capture images of the users and count the number of users captured in the images. In other examples, the tracker 220 may use beams such as infrared beams to track people entering or leaving the site 100. Other devices to count the number of people is also contemplated. The processor 54 may store the count of number of people in the vicinity of the location of the security device 104 via the tracker 220 in the database 34. The processor 54 may additionally store date and time log associated with the count of number of people in the vicinity of the location of the security device 104.

The processor 54 is further configured to receive a count of number of people registered to the security device 104 after successful verification of the cryptographic certificates by the processor 54. For example, the security device 104 may send the count of number of people registered between a predetermined duration of time and update the count at predetermined intervals. In some examples, the security device 104 may send the count of number of people in the vicinity of the location of the security device 104 to the count of number of people registered to the security device 104 at the same time. In some examples, when the tracker 220 is connected to the server 12 directly, the server 12 receives the count of number of people registered to the security device 104 directly from the tracker 220. The processor 54 may store the count of number of people registered to the security device 104 in the database 34. The processor 54 may additionally store date and time log associated with the count of number of people registered to the security device 104.

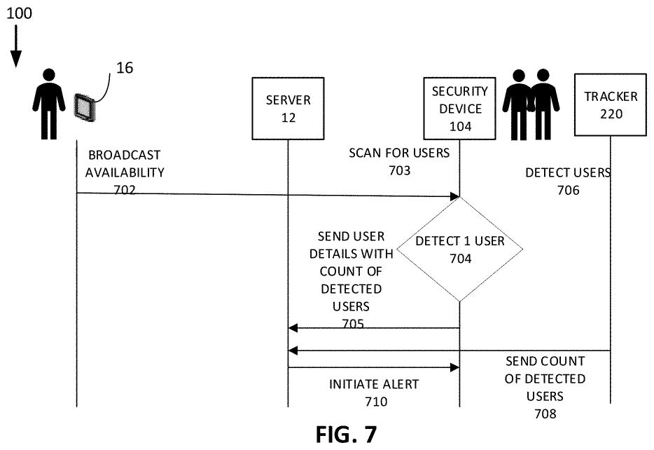

The processor 54 is further configured to compare the count of number of people in the vicinity of the location of the security device 104 to the count of number of people registered to the security device 104 to identify any discrepancy in the number of people visiting the location. The processor 54 may compare the counts at predetermined intervals of time. The processor 54 is further configured to initiate an alert in response to identifying a difference between the counts. Suitable alerts issued by the server 12 include an email, text message, or prompt in a user-interface (e.g., dashboard) provided by the server 12. This is depicted in FIG. 7 which shows two visitors at the site 100 of which one of the visitors is carrying the wireless mobile device 16 and the other visitor is not carrying the wireless mobile device 16.

At step 702, the wireless mobile device 16 broadcasts its availability. At step 703, the security device 104 scans for users within the vicinity of the location. At step 704, the security device 104 detects one user through the wireless interface. At step 705, security device 104 relays detected user details in the form of cryptographic certificate to the server 12 along with the count of number of people registered i.e., one user. At step 706, tracker 220 (containing people detection sensors) detects two users. In this example, one of the two detected users is not carrying the wireless mobile device 16 and hence was not detected by the security device 104 at step 704. At step 708, the tracker 220 sends the count of number of people detected by the tracker 220 (i.e., two) to the server 12. The processor 54 compares the counts received from the security device 104 and the tracker 220 and if the processor 54 identities discrepancy in the number of people visiting the location, at step 710, the processor 54 initiates an alarm. The processor 54 may send the alarm to the security device 104 and the security device 104 may broadcast back to the registered users at the site that there is a discrepancy between registered users and users on site. In some examples, the processor 54 may send the alarm to an administrator of the server 12.

Returning to FIG. 6, the server 12 further includes a lock-access engine 60 that is configured to generate lock-access data 62 based on the lock data 58 and the user account data 56 to allow access to specific physical resources by specific users at specific times. The lock-access engine 60 is further configured to digitally sign lock-access data 40 using the server's private key 32. The lock-access engine 60 is configured to manage logins by users and transmit appropriate lock-access data 40 via the network interface 50 to respective wireless mobile devices 16. In addition, the lock-access engine 60 can be configured to deploy the server's public key 30 to the wireless mobile devices 16.

The server 12 maintains the lock-access data 40 in association with the plurality of user accounts stored as user account data 56. The lock-access engine 60 is configured to transmit lock-access data 40 to a particular wireless mobile device 16 upon the wireless mobile device 16 establishing a connection to the server 12 via the network interface 50 and the user of the wireless mobile device 16 successfully logging into their account. In some examples, the user of the wireless mobile device 16 may obtain some or all the lock-access data 40 required to open locks at the site 100 from the security device 104 when the user of the wireless mobile device 16 is registered with the security device 104. This is advantageous as keys to access the locks at the site 100 are only obtained by the users after registration and not before the visit to the site 100. This is further advantageous as a user of a wireless mobile device 16 does not need access to the greater network because lock-access data 40 is provided by the security device 104 through the short-range wireless interface 204.

The lock-access engine 60 is configured to handle continued access to physical resources while at the same time allowing for access permissions to be revoked. This can be achieved in several ways. In one example, the lock-access engine 60 periodically regenerates the lock-access data 40 with updated permitted access schedules, where such regeneration can be ceased for specific users in order to deny access to the physical resource to such users. Users log into the server 12 to obtain fresh lock-access data 40 for the period. A user who is denied access to a resource will not receive fresh lock-access data 40 for the period and instead will bear expired lock-access data. The risk of unauthorized access is thus inversely proportional to the frequency of regeneration. That is, if lock-access data 40 for each user is regenerated each night to grant access for the following day, then a user whose permission is revoked for a particular resource will still have access for, at most, one day following the revocation. To complement this technique, particularly when a short period of regeneration is selected, the database can further store a regeneration end time for each user, after which lock-access data 40 will no longer be regenerated. This can allow for fresh lock-access data 40 to be generated periodically (e.g., daily, weekly, etc.) within a larger period (e.g., one month), and may be useful in that the administrator does not have to return to the server 12 to actively revoke a permission. In an example use case, a regeneration end time for employees is set to one year and a regeneration end time for contractors is set to the time in the future that the contract is expected to end.

In another example of revoking permissions, the lock data 58 includes version data that is provided to the lock controllers 14. The lock-access engine 60 updates the version data when access permission to any user or users is revoked. Users who are not revoked obtain lock-access data 40 containing the updated version data, which matches that sent by the lock controllers 14, thereby permitting access. Users whose permissions are revoked can only present lock-access data that includes non-updated version data, and the lock controllers 14 are configured to ignore and/or log access requests bearing non-matching version data.

The above two techniques for revoking permissions can be used independently or combined.

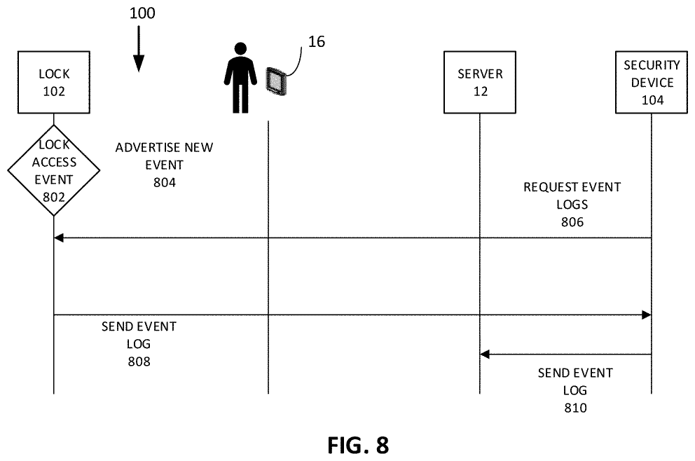

The server 12 further includes a logging engine 64 configured to receive log data from the security device 104, deployed lock controllers 14 and to save long-term lock access logs 66. As previously discussed, the security device 104 may detect different events related to locks which guard the cabinets and relay the events to the server 12 in real-time. This is depicted in FIG. 8.

FIG. 8 shows a process of sending event logs to the security device 104. A user carrying the wireless mobile device 16 accesses a lock 102 located at an entrance of a site. At step 802, a lock access event is created. At step 804, the lock 302 advertises the new lock event. At step 806, the security device 104 requests event logs from the lock 302. At step 808, the lock 302 sends event logs to the security device 104. At step 810, the security device 104 sends the event logs to the logging engine 64 of the server 12. The event logs are saved in the long-term lock access logs 66.

Returning to FIG. 6, the server 12 further includes an admin engine 68 configured to receive updates to user account data 56 and lock data 58. The admin engine 68 is configured to create, modify, and delete user accounts, as well as logically create, modify, and delete lock controllers 14. Further, the admin engine 68 is configured to set access permissions by creating lock-access data 62 for various combinations of users and lock controllers and to revoke access permissions, as needed, by updating version data and/or setting regeneration expiry times.

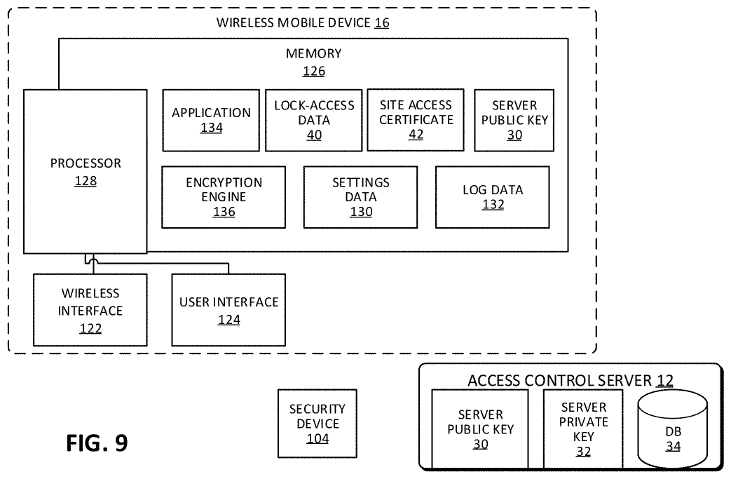

FIG. 9 shows a schematic diagram of a wireless mobile device 16. The wireless mobile device 16 is one example of a wireless mobile device that can be used with the system 10.

The wireless mobile device 16 includes a wireless interface 122, a user interface 124, memory 126, and a processor 128. The wireless interface 122 includes a short-range communications interface, such those discussed above (e.g., Bluetooth, BLE, etc.). The user interface 124 includes a display device, a touchscreen, a keyboard, a microphone, a speaker, or a combination of such. The memory 126 includes any combination of ROM, RAM, flash memory, magnetic storage, optical storage, and similar for storing instructions and data as discussed herein. The processor 128 includes one or more CPUs, microcontrollers, microprocessors, processing cores, field-programmable gate arrays FPGAs, and similar. All or some of the memory 126 may be integrated with the processor 128. The processor 128 and memory 126 cooperate to execute instructions to cause the wireless mobile device 16 to perform the functionality discussed herein.

The processor 128 is configured to communicate with the security device 104 via the wireless interface 122 when the wireless mobile device 16 is in a vicinity of the location of the security device 104. The communication occurs through an application 134.

The application 134 can be configured to provide human-intelligible descriptions for any stored lock-access data 62, such as resource description and location, or to hide lock-access data 62 from the user. Similarly, the application 134 can be configured to provide human-intelligible descriptions for any stored server public keys 30, such as owner name, or to hide server public keys 30 from the user. The application 134 is configured to manage connections and account credentials with the server 12 and to receive lock-access data 40 from the server 12.

The application 134 can be further configured to accept status notifications from lock controllers 14 in vicinity of the wireless mobile device 16 and to respond by retrieving data (e.g., log data) from a lock controller 14 and transporting such data to the server 12 or by obtaining data (e.g., version data or other settings data 130) from the server 12 and transporting such data to the lock controller 14. The application 134 can be configured to facilitate such transport of data irrespective of whether a particular lock controller 14 is to be accessed by the wireless mobile device 16. That is, a wireless mobile device 16 can act as a wireless data proxy between electronic lock controllers 14 and the server 12. Transporting these kinds of data can be hidden from the user, as no user interaction is required.

The wireless mobile device 16 further includes an encryption engine 136. The encryption engine 136 is configured to use the server's public key 30 to validate the authenticity of any certificate provided by electronic lock controllers 14, and to encrypt lock-access data 62 received from the security device 104 or the server 12 using validated public keys of the lock controllers 14. The application 134 is configured to transmit any messages containing encrypted lock-access data 62 to the respective electronic lock controllers 14 via the wireless interface 122. The application 134 can further be configured to use the encryption engine 136 to encrypt data bound by a lock controller 14 using the lock controller's public key.

The application 134 can further be configured to handle discovery/pairing with the security device 104, electronic lock controllers 14, as well as setup and expiry of short-range communications sessions with electronic lock controllers 14, according to the particular communications scheme used (e.g., Bluetooth, BLE, etc.).

The wireless mobile device 16 stores a cryptographic site-access certificate 42 which is shared with the security device 104 and verified by the security device 104 or the server 12 when a user of the wireless mobile device 16 visits a site. The cryptographic site-access certificate 42 is a certificate signed by the server 12 prior to the visit of the user of the wireless mobile device 16. Specifically, the wireless mobile device 16 generates a pair of public and private key for the user and uploads the public key to the server 12. The server 12 signs this information and generates the cryptographic site-access certificate 42 which is shared with the wireless mobile device 16.

The wireless mobile device 16 further stores any lock-access data 62 to be used to gain access to physical resources 20. The wireless mobile device 16 can further be configured to temporarily store settings data 130 in transit from the server 12 to a particular lock controller 14 and log data 132 in transit from a particular lock controller 14 to the server 12. The wireless mobile device 16 is configured to act as a data proxy between the server 12 and the lock controller 14.

As discussed above, concerning operation of the wireless mobile device 16, in overview, to gain access to the location of the site, the user of the wireless mobile device 16 accesses the application 134 to register with the server 12. For example, if the user is using the application 134 for the first time, the user registers with the application 134 first and then is registered with the server 12. To register with the application 134, the user inputs details such as name, email address, contact information, organization details and the like. The application 134 assigns the user with a unique ID and a password. The unique ID and password are then used to sign-in to the application 134. In other examples, if the user has an existing unique ID and password (i.e. a user who has registered with the application 134 before), the user may use existing unique ID and password to sign-in. Once the user is registered with the application 134, the processor 128 generates a cryptographic site-access certificate 42 for the user. The cryptographic site-access certificate 42 contains a public and private key pair for the user and uploads the public key to the server 12. The server 12 signs the public key using its own private key 32 to verify the key and verifies the cryptographic site-access certificate 42. The server 12 sends the verified cryptographic site-access certificate 42 to the wireless mobile device 16.

When the wireless mobile device 16 is in the vicinity of the location of the security device 104, the processor 128 communicates with the security device 104 through the application 134. The processor 128 is configured to send the cryptographic site-access certificate 42 to the security device 104 via the wireless interface 122. The cryptographic site-access certificate 42 may be verified by the security device 104 or the server 12. Once the cryptographic site-access certificate 42 is verified, the user of the wireless mobile device 16 is registered by the security device 104. In some examples, the wireless mobile device 16 may further receive a validation signal 218 from the security device 104 to validate the cryptographic site-access certificate 42. The security device 104 encrypts a message to the wireless mobile device 16 using a public key of the wireless mobile device 16. The validation signal 218 is configured to prompt the wireless mobile device 16 to decrypt the message and respond to the security device 104 with an indication of the decrypted message. The processor 128 is configured to respond to the encrypted message to prove ownership of the cryptographic site-access certificate 42. The validation signal 218 is sent to the wireless mobile device 16 before the security device 16 registers the user of the wireless mobile device 16 as an authorized visitor to the site 100. Thus, if the wireless mobile device 16 does not decrypt the message, the security device 104 does not register the user as an authorized visitor to the site 100.

The processor 128 is further configured to receive an interrogation signal from the security device 104 via the wireless interface 122. The interrogation signal prompt a user of the wireless mobile device 16 for voluntary information concerning the visiting of the user to the location of the security device 104. The voluntary information may comprise reason for visiting the location/site, estimated time duration to spend at the site, details of specific location within the site that need to be accessed, etc. The user of the wireless mobile device 16 inputs the voluntary information through the user interface 124.

In view of the above, the present invention allows protection of physical resources located at the site and the site in general using a security device. The security device tracks users who are on-site through short-range wireless interface and hence provides additional security over the traditional electronic locks as the security device tracks users independent of the specific event when the users access the physical resources. The security device of the present invention can also be provided with the capability of counting the number of users at the site and relay the count to the server which can initiate an alarm in case of a discrepancy in count of registered users vs the count detected by other tracking means by the security device. Thus, access to users not carrying the wireless mobile device can be prevented.

1. A security device comprising:
a network interface;
a short-range wireless interface to communicate with a wireless mobile device in a vicinity of a location of the security device;
a processor coupled to the wireless interface, the processor configured to:
detect a signal received from the wireless mobile device in the vicinity of the location;
receive a cryptographic certificate from the wireless mobile device via the wireless interface, the cryptographic certificate associated with an identity of a user of the wireless mobile device; and
automatically register the user to the location of the security device by verifying the cryptographic certificate or by sending the cryptographic certificate to a server via the network interface for verification.

2. The security device of claim 1, wherein the wireless interface connects the security device to a plurality of lock controllers at the location, wherein the processor is further configured to monitor access to a plurality of electronic locks guarded by the lock controllers.

3. The security device of claim 1, wherein the processor is further configured to send an interrogation signal to the wireless mobile device, the interrogation signal configured to prompt the user for voluntary information concerning a visit by the user to the location.

4. The security device of claim 3, wherein the voluntary information comprises reason for visiting the location.

5. The security device of claim 1, wherein the processor is further configured to detect that the wireless mobile device has left the vicinity of the location when the detected signal vanishes from the vicinity of the location.

6. The security device of claim 1, wherein the processor is connected to a tracker, the tracker configured to detect people in the vicinity of the location and generate visitor detection data.

7. The security device of claim 6, wherein the processor is further configured to process the visitor detection data to count a number of people in the vicinity of the location.

8. The security device of claim 1, wherein the processor is further configured to send an encrypted message to the wireless mobile device to prove ownership of the cryptographic certificate.

9. The security device of claim 1, wherein the processor is further configured to:
send an interrogation signal to the wireless mobile device, the interrogation signal configured to prompt the user for voluntary information concerning a visit by the user to the location;
process visitor detection data captured by a tracker connected to the processor to count a number of people in the vicinity of the location; and
send the voluntary information and the count to the server in association with a registration of the user.

10. The security device of claim 1, wherein the processor is further configured to detect a physical change to the security device, the physical change comprising movement of the security device or tampering with the security device.

11. A server comprising:
a network interface;
a processor coupled to the wireless network, the processor configured to:
receive a cryptographic certificate from a security device via the network interface, the cryptographic certificate being received by the security device from a wireless mobile device in a vicinity of a location of the security device; and
verify the cryptographic certificate using a key of an authorizing party to register the user as an authorized visitor to the location.

12. The server of claim 11, wherein the processor is further configured to initiate an alert when the cryptographic certificate cannot be verified.

13. The server of claim 11, wherein the processor is further configured to receive voluntary information of the user of the wireless mobile device via the security device.

14. The server of claim 13, wherein the voluntary information comprises reason for visiting the location.

15. The server of claim 11, wherein the processor is further configured to receive a count of number of people in the vicinity of the location of the security device via a people tracker.

16. The server of claim 11, wherein: the processor is further configured to:
receive a count of a first number of people registered to the security device via the network interface;
receive a count of a second number of people in the vicinity of the location of the security device via a people tracker connected to the security device; and
compare the first number to the second number to identify any discrepancy in the number of people visiting the location.

17. The server of claim 16, wherein the processor is further configured to initiate an alert in response to identifying a difference between the first number and the second number.

18. The server of claim 11, wherein the network interface connects the server to a plurality of electronic locks at the location, wherein the processor is further configured to monitor access to the electronic locks.

19. A wireless mobile device comprising:
a wireless interface;
a user interface; and
a processor coupled to the wireless interface and the user interface, the processor configured to:
communicate with a security device via the wireless interface when the wireless mobile device is in a vicinity of a location of the security device; and
send a cryptographic certificate to the security device via the wireless interface to register a user of the wireless mobile device as visiting the location of the security device.

20. The wireless mobile device of claim 19, wherein the processor is further configured to receive an interrogation signal from the security device via the wireless interface, the interrogation signal configured to prompt a user of the wireless mobile device for voluntary information concerning the visiting of the user to the location of the security device.

21. The wireless mobile device of claim 20, wherein the voluntary information comprises reason for visiting the location.

22. The wireless mobile device of claim 20, wherein the processor is further configured to prompt the user to input the voluntary information via the user interface.

23. The wireless mobile device of claim 19, wherein the processor is further configured to decrypt an encrypted message received from the security device to prove ownership of the cryptographic certificate.
